(19) United States
(12) Patent Application Publication
(10) Pub. No.: US 2005/0067381 A1
(43) Pub. Date: Mar. 31, 2005

(54) On-site rail welding apparatus

(76) Inventor: Daniel J. Coomer, Park Forest, IL (US)

Correspondence Address: BARNES & THORNBURG, P.O. BOX 2786, CHICAGO, IL, 60690-2786, US

(21) Appl. No.: 10/985,817

(22) Filed: Nov. 10, 2004

Related U.S. Application Data
(63) Continuation-in-part of application No. PCT/US03/02470, filed on Jan. 27, 2003.

(51) Int. Cl. B23K 9/00

(52) U.S. Cl. 219/54; 219/125.1

(57) ABSTRACT

An on site railroad rail welding repair apparatus wherein a railroad rail is an operating railroad track and a defect in the rail has been removed to provide a void and a rail-void interface while maintaining continuity of the rail having pair of cooling blocks which have an internal configuration to complement the rail, and an arc welder that fills the void with appropriate molten metal and causes the molten metal and the rail at the rail-void interface to bond. Also, a robotic welding apparatus and a weld containment apparatus engageable with the rail-void interface by movement having a pivotal and longitudinal component. Further, a mobile weld delivery unit delivering materials through an umbilical to a robotic welding apparatus having a welding device proximate the rail-void interface so that a weld can be made joining the rail-void interface.

### CLAIM OF PRIORITY

This application is a continuation-in-part of our PCT Application PCT/US2003/02470 filed Aug. 8, 2003 claiming priority from our provisional application Ser. No. 60/402,184 filed Aug. 9, 2002.

### BACKGROUND

1. Field of the Invention

The invention relates to a rail welding apparatus for repairing a railroad rail having a defect in the top portion of the rail wherein the defect is cut out to provide a rail void and rail-void interface and the apparatus welds the rail-void interface on site.

2. Description of Related Art

Railroads have to maintain their track to ensure safe operation of trains. Some of this maintenance is centered on the repair of rail defects. Railroad rails may be manufactured with internal defects or, as a result of wear-and-tear or fatigue, develop defects. These defects are found using non-destructive test methods. The Federal Railway Administration (FRA) mandates periodic ultrasonic testing of railroad rails to locate defects in the rail. When a defect is found, a temporary accommodation or a repair must be made to the track structure. Many of these defects are located in the top portion (i.e. the head and/or web) of the rail.

There are two common welding processes used to facilitate the repair of defects in railroad rails. They are the thermite welding process and the flash-butt welding process. Rails repaired using a flash-butt weld is typically stronger and higher in quality than those repaired using a thermite weld. Repairs made using the thermite process are initially less costly due to the labor and additional equipment cost components required using the flash-butt process. Additionally, rail defects may be temporarily repaired through the use of Joint Bar splices (mechanical joints). The rail integrity is best maintained by having the lowest number of joints (mechanical or welded) in the track.

When repairing a rail defect, a length of rail localized around the defect is removed from the existing rail. This creates a gap (typically 13 to 19 feet in length) in the rail. A rail plug is inserted in the resulting gap to make up for the bulk of the rail length removed. A weld is then made at each end of the rail plug, welding the rail plug to the existing rail, and creating a continuously welded rail.

Regardless of the welding process used to install the rail plug, there is a need to maintain the Adjusted Rail Temperature (ART). The ART is the temperature at which the rail contains no longitudinal thermally induced rail stresses. The track is not designed to allow the rails to contract and expand in response to environmental temperature changes. It is designed to constrain the rail and to allow the rail to have tension and compression. The amount of tension or compression is determined by the ART and the Current Rail Temperature (CRT). The ART must be controlled because too low of an ART can cause the rail to buckle when the CRT of the rail is too high and too high of an ART can cause the rail to pull apart when the CRT of the rail is too low. Buckles and pull aparts cause unsafe conditions and can cause serious accidents.

When a repair is accomplished by installing a rail plug, it is unlikely that the rail plug installed will be of the exact length necessary to maintain the ART of the rail. The ART of the rail is altered. As such, the installed segment will have a different ART than desired. The ART of the entire rail adjacent to the repair plug installation is changed. Management of the ART could be simplified if the rail was not severed during the repair of a defect.

A thermite weld can be used to weld the existing rail to a rail plug. A rail plug is cut to a length approximately two inches shorter than the length of the rail, containing the defect, which is being cut out. The rail ends to be welded are aligned. A sand mold is attached to both the existing rail and the rail plug around an approximate one-inch gap between the end of the existing rail and the end of the rail plug. The thermite charge is contained in a crucible immediately above the sand mold. After the mold is pre-heated, the thermite charge is ignited. The thermite charge creates molten steel which pours into the sand mold. As the molten steel solidifies, it forms a casting which bonds to, and is contiguous with, both the existing rail and the rail plug. In this manner, the rail plug is welded to the existing rail to form a continuous section.

The rail ends at the other end of the rail plug are aligned. A second thermite weld is made at an approximate one-inch gap at the opposite end of the rail plug, joining the rail plug to the existing rail. The area of the rail containing the thermite weld is not as strong as and is not of the same quality as a normal rail. Moreover, such welds are not clean as they can include numerous inclusions from the welding process. As such, the thermite welds typically require subsequent repairs in order to maintain the railroad rail in a safe condition. This method also requires the repair crew to transport a rail plug to the repair site and the section of the rail containing the defect away from the site.

A flash-butt weld can be used to weld the existing rail to the rail plug. A rail plug is cut to a length approximately three inches longer than the length of the rail, containing the defect, which is being cut out. Rail anchors are removed from the existing rail until the gap created by the removal of the defect containing the plug is three inches longer than the defect containing the rail plug. This can only occur when the CRT is below the ART. When the CRT is below the ART, the rail is in a longitudinally tensile condition. The rail plug is put in to place in the track. The rail ends to be welded are aligned. A flash-butt welderhead is clamped across the abutment of the rail plug and the existing rail. The flash-butt welding cycle is carried out. The welderhead passes a high current across the interface between the existing rail and the rail plug. The current produces arcing between the mating surfaces. The arcing produces heat in both rails as well as a “flashing” away of the surfaces. As the cycle progresses and sufficient heat has been generated, the welderhead forges the two pieces of rail together to form an essentially single rail. The flashing away of the rail and the forging of the rail consume about one and one half inches of the rail from the rail plug. In this manner, the rail plug is welded to the existing rail to form a continuous section. A shear die is then pushed across the weld to remove the upset material and to return the profile to the rail contour.

The rail ends at the other end of the rail plug are aligned. The flash-butt welderhead is moved to the other end of the rail plug and clamped across the abutment of the rail plug and existing rail. The rail consumed during the production of the first flash-butt weld of the rail plug has created a gap at the location for the second weld. The rails are stretched to close the gap and the flash-butt weld cycle is carried out. The flash-butt weld consumes about one and one half inches of the rail at the second weld location. The rail is now returned to the pre-existing tensile condition. Rail anchors are placed onto the existing rail. The flash-butt welding process is typically more costly than a thermite process but produces a cleaner and stronger weld. However, this method also requires the repair crew to transport a plug to the rail repair site and the section of the rail containing the defect away from the site.

When rail plugs are installed using either the thermite or the flash-butt welding process, the rail is taken out of service. This prevents the railroad from running revenue producing trains. Thermite and flash-butt welding trucks need to occupy the track. The installation of a rail plug and resulting two welds uses valuable track time and needs to be kept at a minimum.

Joint Bar splices are, essentially, a reinforcing clamp applied to the rail to affect a temporary repair. A Joint Bar splice is used when there is not enough time to perform a complete repair or when other repair materials are not available. A Joint Bar splice, by government regulation, is a temporary repair and must be replaced within about 90 days. The Joint Bar splice reduces the operational limit of the rail in the repair area.

In the area of gas shielded arc welding of railroad rails, several approaches have been taught, although they have not necessarily met with functional success in the field. These include U.S. Pat. Nos. 6,407,364, 6,278,074, 6,207,920 and 6,201,216, all entitled “Method and system for welding railroad rails” and U.S. Pat. No. 5,605,283 entitled “Weld joint between two rails arranged behind each other along a rail track.” Fixtures for rail welding are taught in U.S. Pat. No. 6,396,020 entitled “Rail welding apparatus incorporating rail restraining device, weld containment device and weld delivery unit.” A key portion of computer robotic control for rail welding is taught in publication WO 0195132 entitled “Gap Welding Process.” U.S. Pat. Nos. 5,605,283, 6,396,020 and WO 0195132 are all assigned to the same company as this application. All of the above patents, U.S. Pat. Nos. 6,407,364, 6,278,074, 6,207,920, 6,201,216, 5,605,283, 6,396,020 and WP 0195132 are incorporated by reference as if fully set forth herein.

In addition to the above, it has been found that the amount of heat introduced into the rail during welding or gap closure can produce an annealing effect at the rail interface. This can, in turn, result in the migration of carbon from the rail as well as a change in microstructure and material properties.

Moreover, the welding process can introduce hydrogen (H₂) into the final weld which has the effect of embrittling the weld material and causing a weld failure.

Thus, it is desirable to provide a rail defect repair system that addresses above-identified issues and is acceptable to railroads for their use.

### SUMMARY

The aforementioned issues can be addressed by solutions offered by the instant welding apparatus. As more fully described below, the welding apparatus repairs a railroad rail defect in a portion of the rail and more preferably in the rail head or in the rail web, or in the rail head and rail web.

As more fully detailed hereinafter, our welding apparatus provides a clean weld, a weld as strong as the parent rail, has a small heat affected zone (HAZ), provides a good bond with the rail, does not exhibit hydrogen (H₂) embrittlement, deals with the issues of ART and CRT, and avoids transporting long sections of rail.

Other and further features of the invention will be obvious upon an understanding of the illustrative embodiment about to be described, or will be indicated in the appended claims and various advantages not referred to herein will occur to one skilled in the art upon employment of the invention in practice.

### BRIEF DESCRIPTION OF THE DRAWINGS

The description which follows, and the embodiments described therein, is provided by way of illustration of an example, or examples of particular embodiments of the present invention. These examples are provided for the purposes of explanation, and not of limitation, of those principles and of the invention. The drawings are not necessarily to scale and in some instances proportions may have been exaggerated in order more clearly to depict certain features of the invention.

FIG. 1 is a side elevational view of a railroad rail with a defective portion removed.

FIG. 2 is a sectional view taken along lines 2-2 of FIG. 1.

FIG. 3A is a front elevation of a rail clamp.

FIG. 3B is a side elevation of a rail welding alignment device.

FIG. 3C is a top plan view of FIG. 3B.

FIG. 4 is a front elevation of the rail weld containment device.

FIG. 5 is a top plan view of the rail weld containment device.

FIG. 6 is a sectional view of a weld delivery unit.

FIG. 7 is a top plan view of an alternative embodiment of the weld delivery unit.

FIG. 8 is a side elevation of a guide rod of the weld containment device.

FIG. 9 is a front elevation of the guide rod of FIG. 8.

FIG. 10 is a side elevation of the cam guide of the weld containment device.

FIG. 11 is a front elevation of the cam guide of FIG. 10.

FIG. 12 is a top plan view of the preferred rail welding alignment device.

FIG. 13 is a front elevation view of the preferred rail clamp on the rail welding alignment device.

FIG. 14 is a sectional view of the preferred rail clamp on the rail welding alignment device showing the clamping arms in open and closed positions.

FIG. 15 is an enlarged section of the twist pin and cam adjustment of the weld containment device.

FIG. 16 is a side elevation of the preferred twist pin of the weld containment device.

FIG. 17 is a front elevation of the twist pin of FIG. 16.

FIG. 18 is a side elevation of the preferred cam guide of the weld containment device.

FIG. 19 is a front elevation of the cam guide of FIG. 18.

FIG. 20 is a rear elevation of the alternate embodiment of the weld delivery unit.

FIG. 21 is a side sectional view of the alternate embodiment of the weld delivery unit.

FIG. 22 is a top plan view of the alternate embodiment of the weld delivery unit.

FIG. 23 is a top plan view of the preferred rail alignment with robotic welding device.

FIG. 24 is a side elevation of FIG. 23.

FIG. 25 is a sectional view of an embodiment of the van supporting the weld delivery unit using a separate robot.

### DETAILED DESCRIPTION

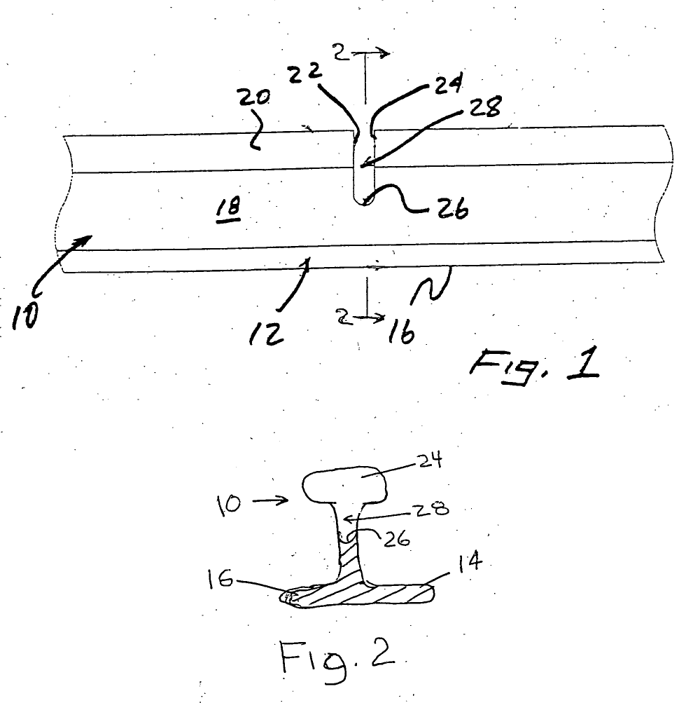

FIG. 1 illustrates a railroad rail 10 having a base 12 with opposed flanges 14, 16, an upstanding web 18 extending upward from the base 12 between the flanges 14, 16 and a head 20 at the top of the web. The use of our welding apparatus begins when a rail defect is identified and located, such as by using an ultrasonic rail-testing car and then removed to provide a slot or rail-void interface 28 that has opposing vertical walls 22 and 24 and a rounded base 26. The ultrasonic rail-testing car can precisely locate and mark the area of the rail containing the defect. Additionally, manual testing of the defect may further delineate the areas of the rail which contain the defect. For illustrative purposes we show that the ultrasonic testing confirmed that the defect is totally contained in the rail head 20 and web 18. The top portion of the rail is then removed, as more fully described below. Although this top portion is directed to the rail head and portion of the web, the top portion can include a selected portion of the rail head, or the entire rail head, and when necessary a selected portion of the rail web, the entire rail web, and when necessary a selected portion of the rail base. However, the rail is not completely severed and is still connected and continuous as only a portion of the rail has been removed. When the entire rail is severed the system as described in our U.S. Pat. No. 6,396,020 and U.S. application Ser. No. 10/118,481 are used.

To repair the defective rail, the top portion of the rail containing the defect is removed. The removal is preferably accomplished by machining a slot in the head and the web of the rail, or by hole coring and cutting of the rail, by grinding the rail or by machining the rail, but other methods may be used. Hole coring or drilling in the web initially leaves a round aperture, with the cutting of side walls 22, 24 through the hole, leaving a weld-void interface semicircular bottom 26. Machining, grinding or other methods leave a void or a slot with various geometry at the bottom. Some geometries are preferential to certain filler weld processes. The preferred geometries are a beveled bottom or a double J (i.e., opposed J shapes) shaped bottom.

Because only the top portion of the rail 10 is removed, there is no change in the length of the rail and the ART remains unaffected. There is no need to accurately align the rail heads because the rail head is held in alignment by the lower portion of the rail which has not been removed for replacement.

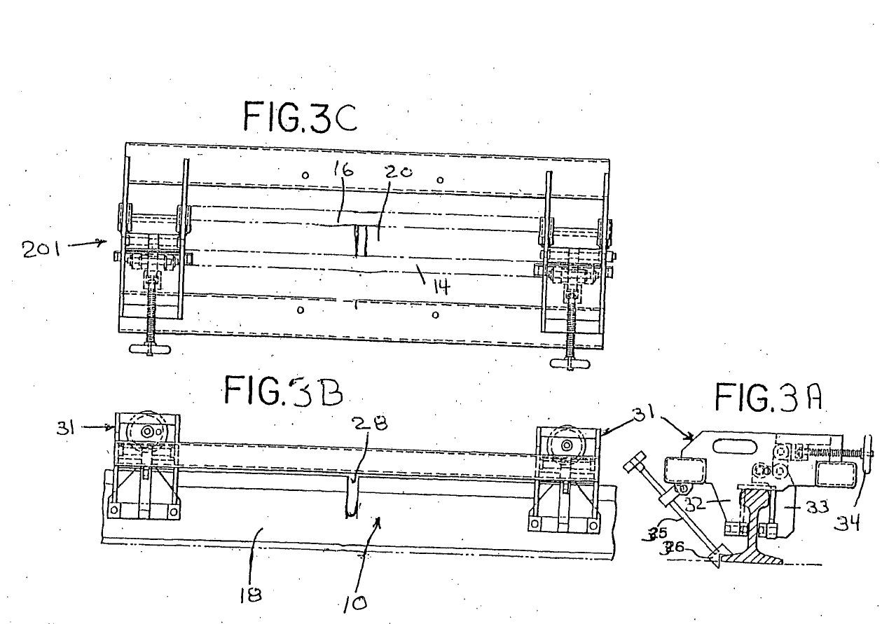

Referring to FIGS. 3A-3C, the rail welding apparatus has rail repair alignment device 201 that has a pair of clamps 31. Each of the clamps has a fixed clamp member 32 and a movable clamp member 33. One of the clamps will engage the rail on one side of the rail-void interface to be welded and the other clamp will engage the rail on the other side of the rail-void interface.

Each moveable clamp member 33 has an eccentric pivoting action and can be clamped in place by the action of hand wheel 34. A horizontal plate supports the device on the crown of the rail.

Each of the clamps is provided with a base twist assembly. The twist assembly bears at an angle through a shaft 35 on a pad 36 that engages the rail base 12. In this manner, the welding apparatus can be aligned with the rail-void interface 28 to enable the next step of the operation utilizing the weld containment device.

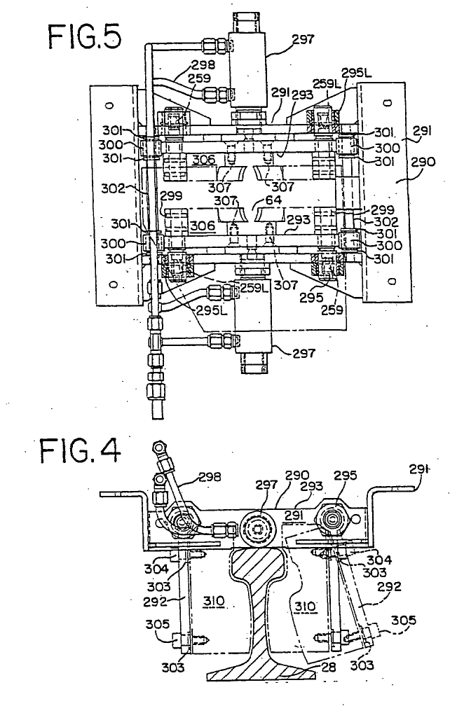

Referring to FIGS. 4 and 5 a weld containment device 290 works with the rail repair alignment device 201. The weld containment device connects to or can be part of the repair alignment device 30. While preferably used together, and providing unique advantages in combination, weld containment device 290 may be suitable for other welding operations, merely providing its advantages in compactness and rapid deployment.

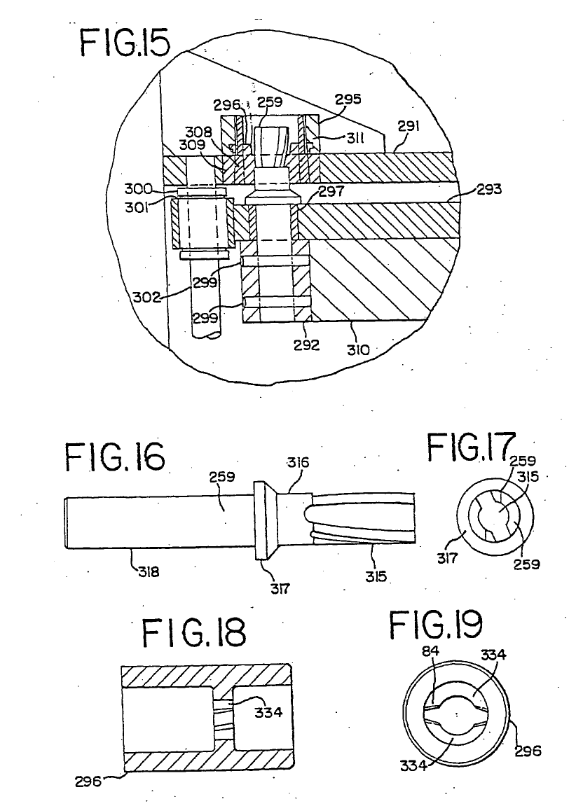

The weld containment device 290 is generally loosely secured to the rail repair alignment device 201 using four clamps 287 (FIG. 12) which allows the weld containment device 290 to automatically center itself when the cooling blocks 310 are deployed.

The weld containment device 290 is set up on a rigid frame 291. Two yokes 293 are actuated by a pair of cylinders 297 mounted exterior to frame 291 and the cylinder rods are connected to the yokes 293 causing them to move inwardly. Cylinders 297 are operated through pressure transmitted in hydraulic fittings 298 in the ordinary manner of hydraulic operation. The yokes are mounted on two linear bearings or bushings 300 secured to the yoke using shoulders 301. Other fasteners, such as snap rings, might be suitable, but need to have adequate strength. The bearings 300 slide on two hardened steel shafts 302. The shafts cause the motion of the yoke to be precisely linear and parallel with each other.

A twist pin 259 is rigidly connected to the block holders 292 through the use of pins 299 preventing rotation of the twist pin 259. Cooling blocks 310, preferably constructed of copper, are connected to the block holders 292 by a plurality of fasteners 304 and 305. The cooling block 310 and corresponding block holder 292 are the major components in the swinging components referred to generally as the quadrants 294.

A smaller non-moving cooling block 306 is held to the frame 291 by a plurality of fasteners 307. As the cylinder extension causes the motion of the yokes inward from the open position to the closed position, the action of the twist pins 259 engaged by the cam guide 296 causes a rotation of the quadrants 294. The scope of the swing may be as little as about 15 degrees to about 30 degrees with about twenty degrees currently preferred.

In the preferred embodiment, in FIGS. 4-5 and FIGS. 15-19, adjustment of the precise rotation of the cam guides 296 is provided through the use of an adjustable hub device 295. This device 295, which is commercially available and is sold under the trademark Trantorque, uses twin tapered shaft segments 308, 309 to impinge on the cam guide 296 while at the same time impinging on the hole in the frame 291. This operates in a manner analogous to a collet, release of the load on the tapered shaft segments 308, 309, by loosening adjusting nut 311, and permitting movement of the cam guides 296.

Precise adjustment of the cam guides 296 provides for a tightening effect as the blocks 310 contact the rail on the extend stroke. A compliant fit of the blocks 310 against the cutout rail 10 is provided by a pair of springs 303 in each block.

Cooling blocks 310 and 306, when in place on the rail, provide for a welding head aperture 64 through which the welding head can fill the rail web and head as described below, even when the blocks are closed and the shoe quadrants touch on the extend stroke.

During the return stroke, the yoke 293 pulls the quadrants 294 back by engaging a shoulder 317 on the twist pin shaft 318. This shoulder 317 holds the quadrant in relative proximity while still allowing a rotation about shaft 318. Since the twist pins 259 are fixedly fastened to the quadrants, parting of the containment shoes is accomplished by pulling the pins apart. The clearance is preferably somewhat less than about one and one half inches (1.5″) thereby providing access to the rail-void interface 28 of about 1 to 3 inches, yet providing a level of preload on the yoke and quadrant arrangement.

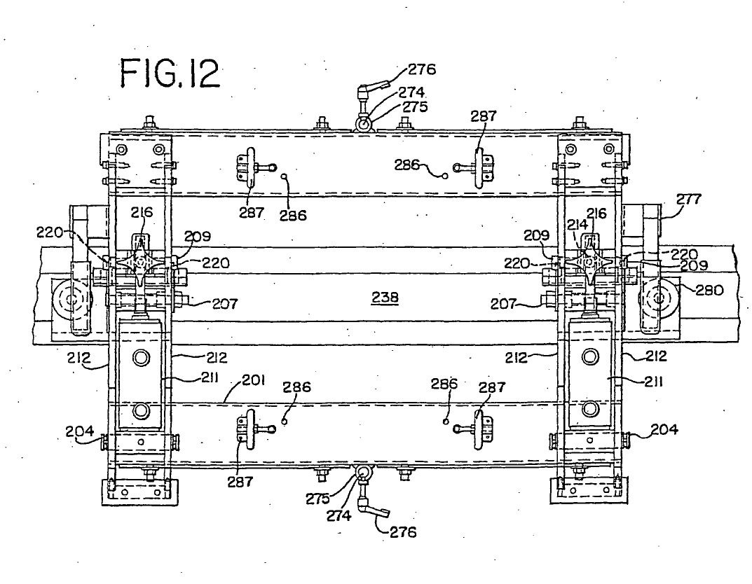

An early prototype pin or rod 45 for right hand travel is shown in FIGS. 8 and 9. Cam portion 65 has twist to provide 30 degrees rotation in ¾ to 1-3/4 inches of travel. Shaft portion 66 is provided with groove 67 to receive ring 53. Knurled or splined portion 68 abuts head 69. Preferably about thirty two teeth will be formed in splined portion 68. Head 69 fits in aperture 70 in holder 72. A press fit into aperture 70 is anticipated. At the quadrant end, set screw 52 also serves to firmly fix the unit in position. In certain embodiments, a large number of small profile splines could be used with mating splines in the frame 291 to enable some level of adjustment by removal and replacement at a different alignment. This would enable mechanical adjustment but would be limited in the increments available by the size and number of splines. The preferred arrangement permits adjustment in infinite increments and is expected to be adjustable in the field.

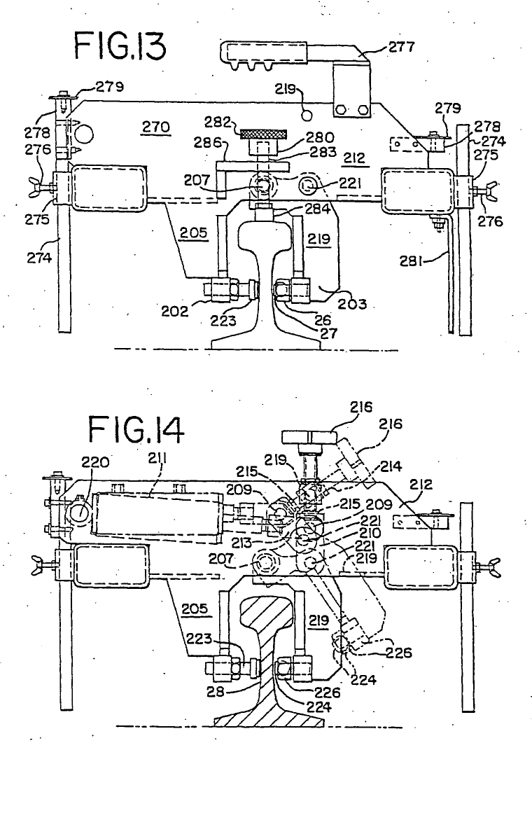

The early prototype cam guide 46 in FIGS. 10-11 has a body portion 80 and aperture 82 with opposed lobes 84 receiving cam portion 65. Lobes 84 could be formed with a profile enabling them to receive either the right or left hand cam portions 65. For improved strength and precision, however a left and right cam guide could also be provided.

The twist pin 259 (FIG. 16) is designed to have about 15-30 degrees of rotation in about ¾ to 1 3/4 inches of linear travel with 15-20 degrees being preferred. One set of twist pins 259 and cam guides 296 will have right hand travel and the other set 259 L and 296 L left-hand travel (FIG. 5).

The twist pin 259 and cam guide 296 for right hand travel is shown in FIGS. 16-19. Cam portion 315 is shown having a twist of 15 degrees rotation in three quarters inch (¾″) travel. However, 20 degrees may be preferred. Shaft portion 316 is provided with a shoulder 317. Shaft end 318 provides for insertion into the block holders 292 and through bushing 297 and secured with pins 259.

Cam guide 296 has a body portion 330 aperture 332 with opposed lobes 334 receiving cam portion 315. Preferably lobes 334 can be formed with a profile enabling them to receive either the right or left hand cam portions 315. For improved strength and precision, however a left and right cam guide could also be provided. The degree of twist will conform to that of the corresponding pin 259, 259 L.

Unlike the prior art, this geometry for operating quadrants 294 permits operation in very close clearance locations. The combination of longitudinal movement of yokes 293 into and out of engagement and the outward swinging of block holders 292 on horizontal, longitudinally aligned shafts 302 and pins 259 enables adequate clearance for the welding head to move reciprocally and vertically to weld the rail bases together, while closing the blocks to maintain the welding material in the web, and thence such clearance as is necessary to weld the head of the rail. This movement provides for both effective welding and compact size.

The blocks 310 conform to the profile of the rail 10 for the purpose of containing molten material as the weld progresses. The welding operation will be accomplished by the following steps: placing a ceramic base mold below the rail base and then commencing the welding operation whereby approximately a 1 to 3 inch void between the rail walls 22 and 24 is filled by welding material.

Using a continuous precisely controlled welding cycle will move the welding element back and forth across the void resulting in the filling of the void with metal material having mechanical properties commensurate with that of the metal in the rail itself. To control this weld, the transverse distance the welding element will travel at the head being a long distance, while only a short distance of travel is necessary in the web portion. As the welding operation progresses in a vertical manner through the web of the rail, the blocks will be closed on the web to maintain the molten material in place. The weld will progress up the web while the blocks provide the required containment yet also providing the necessary clearance for the welding element. This movement can be controlled and coordinated by processing data on positioning and the like received from a robotic controller.

A specific welding procedure will be a function of the welding unit used, which is not a part of this invention. For example, arc welding could be used, while theoretically, gas welding, aluminothermic bonding, electroslag, portable foundry or thermite welding may be adapted to take advantage of certain aspects of the invention, such as weld containment. The preferred welding method would be arc welding. However, great flexibility is provided by the invention adaptable to the metallurgy of the rails, the equipment available, and the equipment in operation at any particular time.

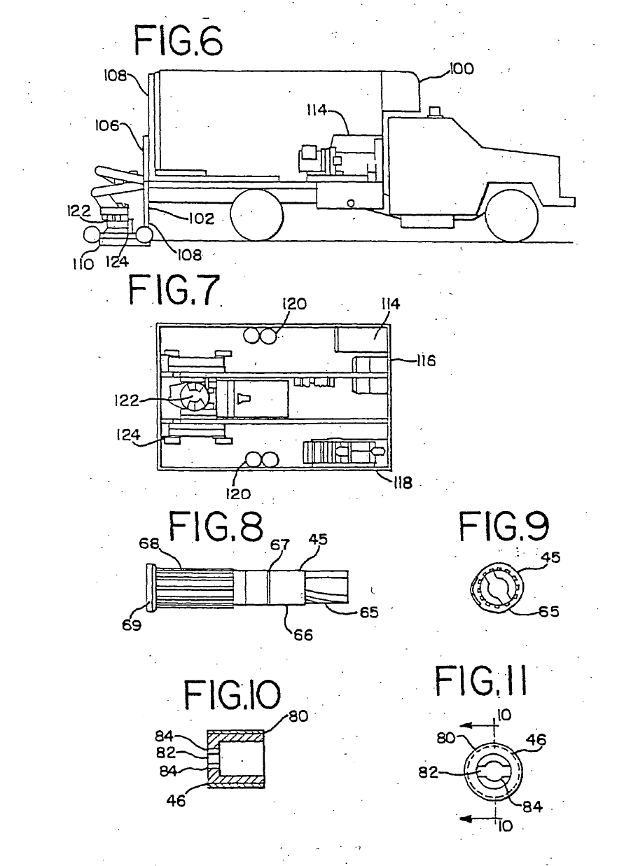

One possible weld delivery unit 100 alternative, shown in FIG. 6-7, will have a frame 102 mounted in truck 104. A vertical support piece 106 fits sliding rack 108. Vertical support piece 106 at its lower portion 108 supports horizontal cradle 110 adapted to have rail engaging bogie wheels 112. Thus, the device can be raised for transportation, maintenance, or the like, and lowered for alignment on the railroad rail to reduce the load on the structure and steady the unit for operation and enable indexing to the rail, the welds along any given section of rail being staggered as between the left and right rail head.

The weld delivery unit 100, as shown in FIG. 25, has sufficient space to receive the welder 114 itself; control devices 116 generator 118, induction heater 502, boom not shown and shielding gas 516; as well as the welding robot 500 shown in FIG. 24 stored on the unit 100 retracted in the body of the truck for protection and ease of transportation.

As taught in FIGS. 6-7 the alternative weld delivery unit is basically indexed to the rail 10 by virtue of cradle 110 and bogie wheels 112. This provides an advantage in quick movement and lack of bracing or other connection to the roadbed. In certain conditions this type of alignment could have significant utility.

The preferred weld delivery unit 100, shown in FIG. 25, will essentially be a welding skid 506 mounted in a transport vehicle such as a truck 104. Equipped with a boom not shown, the weld delivery unit 100 can deploy the rail repair alignment device 201, the weld containment device 290 and the portable welding robot 500 which together are called the robotic welding head 508. The robotic welding head 508 has a welding range from the weld delivery unit 100 that is only limited by the length of the umbilical 510 which supplies the robotic welding head 508 with commands, power and coolant.

The preferred rail repair alignment device 201 (FIGS. 12-14) which provides the structure on which the clamps 31 are mounted in pairs. One of the clamp pairs would engage the rail on one side of the rail-void interface 28 and the other clamp would engage the rail on the other side of the rail-void interface. Fixed clamp member 202 has downwardly depending arm 205 with a clamping member including a pad 223 that provides a base against which the rail 10 can be clamped, and provides the requisite electrical contact as may be required by the welding operation. These are paired for each clamp assembly.

The movable clamp member 203 with downwardly depending arm 219 has an eccentric pivoting action around pin 207 which can be clamped in place by the action of a cylinder 211. The rod 225 of cylinder 211 is fastened to a clevis 208 and pinned to a link 210 with a pin 209. The rotation of link 210 is constrained by link adjustment assembly 213 which is composed of a rotating structural beam 212, a screw 214 penetrating through the beam 212 with a rotary joint 215 connected to the clevis 208 and pin 209 using a block 217. Block 217 rotates around pin 209. The force applied by the cylinder acts through the clevis pin 209 with a variable reaction force taken by the shoulder bolts 220 directing a clamping force downward against moveable clamp. The structural beam 212 is held in the rail repair alignment device 201 using shoulder bolts 220.

It will be seen that said arm 203 has an inverted L shape with pin or pivot 207 being located proximate the end of the short leg of the L. Pin 221 provides the second pivot, this being located proximate the intersection of the short leg of the L and the long leg of the L. Clamping pad 225 is located at the end of the long leg of the L.

The length of this link adjustment assembly 213 is controlled by rotation of a hand wheel 206 attached to the screw 214. The length of the final adjustment length of the link adjustment assembly 213 is held in place using check nut 222 for locking.

Link adjustment assembly 213 provides one arm in a scissors arrangement with link 210 providing a second arm and the top portion 218 of clamp 203 a third. The extension or retraction of cylinder 211 acting on pivot 209 results in the pivoting of link adjustment assembly at pin 209 and bolts 220. Link 210 pivots at pins 209, 221 and portion 218 around pins 207, 221 results in exertion of a substantial clamping force owing to the fixed positions of pins 207 relative to bolts 220 in beam 212.

The force applied by the cylinder acts through the clevis pin 209 with a variable reaction force taken by the shoulder bolts 220 directing a clamping force downward against moveable clamp 203 and carried on ball unit 224 fastened by nut 226. The cylinder is mounted in the beam 212 of repair alignment device 201 with cylinder mounting pins 204.

Stabilizing legs 274 are adjustable and provide additional stability of the rail restraint support. The legs 274 are allowed to slide in the bushing 275 and held in place with setscrews 276 which may alternatively be actuated with wing nuts (FIG. 13) or handles (FIG. 12) or other appropriate manual gripping end. The rail repair alignment device 201 is lowered into place by use of the boom located on the weld delivery unit 100.

By comparison to the alternative embodiment, the use of legs 274 provides a platform fixed relative to the ground or roadbed. This enables the use of various bars, clamps and jacks, familiar to one in the track art, which may be hooked or otherwise fixed to a rail and jacked against the ground or roadbed to directly control twist. In addition to the greater precision of alignment this also enables track workers to use familiar alignment and adjustment tools as may be necessary to specific jobs.

Depending on the type of welding robot used, touch sensing plates 279 may need to be attached to blocks 278 which are attached to the frame 270 to allow the robotic controller to establish the location of the rail repair alignment device 201 and thence the weld void by touching the plates with an electrically live torch tip. Pluralities of these plate assemblies are mounted on the frame 270 for accurate location of the weld void. Around the perimeter of the frame 270 are located a plurality of windscreens or flaps 281 for prevention of ambient winds affecting the gas shield of the welding process.

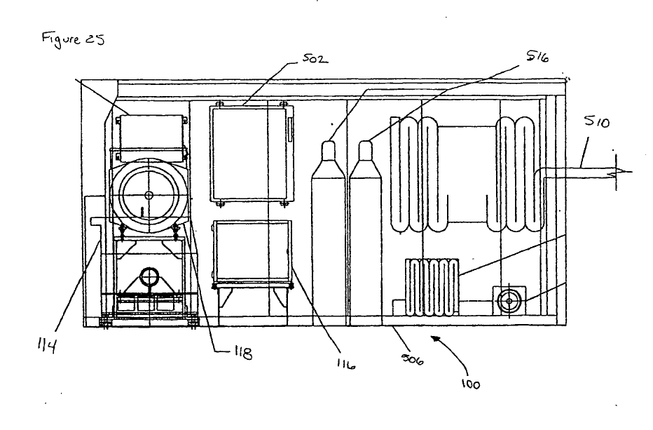

When the preferred portable welding robot 500 is used, as shown in FIGS. 23-25, and attached to the rail repair alignment device 201, the touch sensing plates are unnecessary since they are a single unit and the robot welder no longer needs to orient itself to the rail repair alignment device 201. Also when the portable welding robot 500 is attached to the rail repair alignment device 201, the robotic welding head 508 can be enclosed in an environmental protection shield 512.

The rail repair alignment device 201 is supported on the rail using jacking screw assemblies 280 in which handle 282 rotates screw 283 mounted in a fixed horizontal plate 286 by threading, and having rotary shoes 284 attached to the end of screw 283. Shoe 284 is positioned so as to be centered on and bear against the head of the rail 10. In this manner, clockwise rotation of a right hand threaded screw 283 will raise rail repair alignment device 201.

The preferred embodiment includes the use of the hydraulic cylinder 210 and scissors mechanism; use of adjustable legs 274 and screw assembly 280 and addition of the portable welding robot 500 and environmental protection shield 512 for superior weld control.

The preferred weld delivery unit 100 (FIG. 25) will consist of a welding skid 506 that can be attached to a common truck chassis specially equipped to be operable on railroad rail by use of front and rear rail-engaging bogies. Mounted on the truck chassis is a van-style cargo box, which houses and protects all of the associated process equipment. The process equipment includes a welder 114, a portable welding robot 500, a robot controller 116, and an induction heating system 502. Alternatively, the welding skid 506 can be used as a stand alone unit or can be mounted in a transport container or other device that can be moved to the welding site.

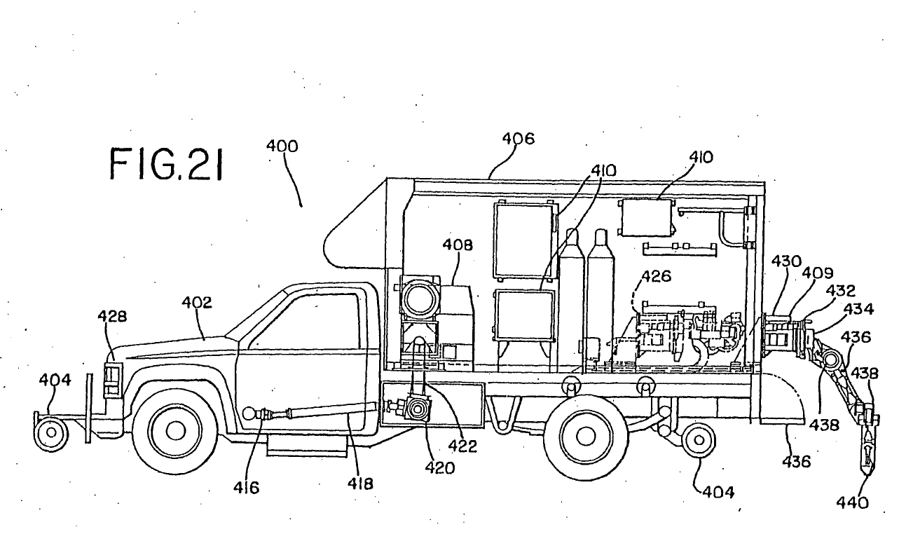

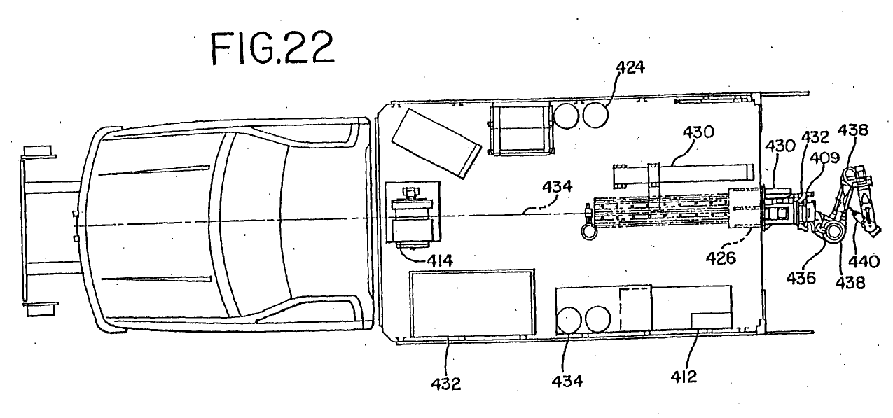

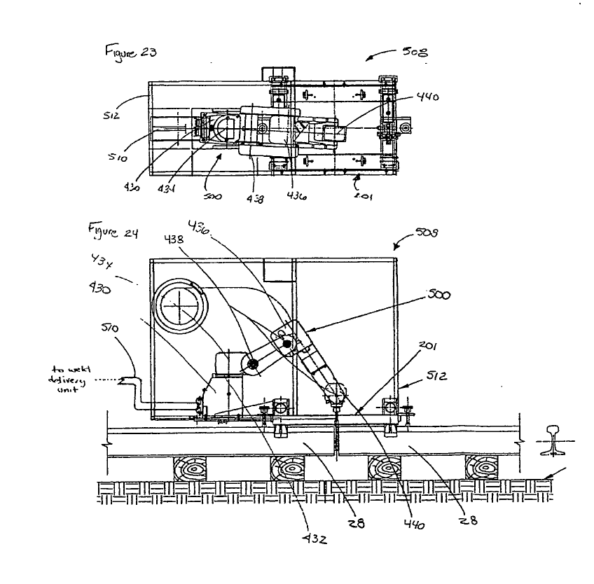

Auxiliary equipment includes an electric power generator 118, driven from the truck engine through a power take-off transmission 416, as shown in FIG. 21, and drive shaft 418 through a right angle gear box 420 and a belt drive 422. Alternatively the generator 118 can be powered by a separate gas engine. Gas bottles 516 for welding shielding gas are also provided. A hydraulic system 428 which can be belt-driven from the truck engine provides hydraulic power to operate the rail repair alignment device 201 and weld containment device 290. Various tools and devices to assist in alignment of the rail are also stored on board in tool case 432 and storage rack 434. A drop-down tool shelf 436 allows for temporary storage of frequently used tools and supplies.

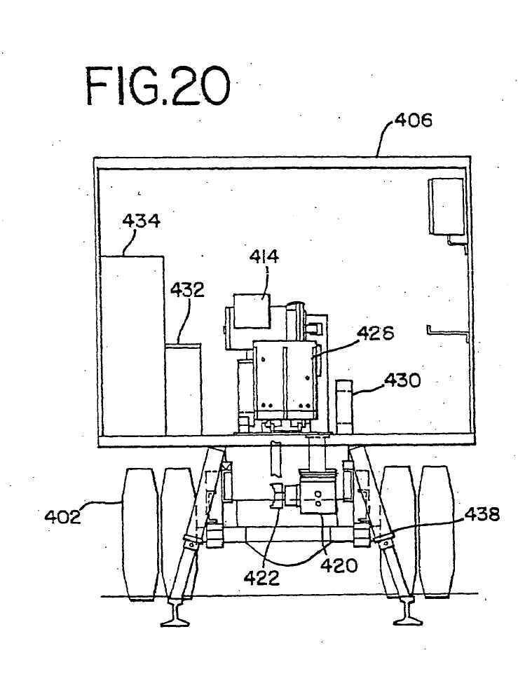

The cargo box can be stabilized, as shown in FIG. 20, by use of external stabilizer legs 438 which are hydraulically operated to keep the cargo box from swaying.

The portable welding robot 500, best shown in FIGS. 23 and 24, is mounted to the rail repair alignment device 201 which increases the accuracy of the robot 500 during weld orientation and operation. It will be seen that the robot, as is known to one in the robotics art, has a base 430 mounted to rotational bearing 432 which enables the robot to rotate around a rotational axis 434. As is typical of robot devices, robot 500 has articulated arm 436 which is articulated to bearing 432 and base 430 having a series of joints 438 and, for this application, terminates in welder head 440. While the robot 408 is typical in that it operates in three dimensions using controller 410, the ability to remotely place the robot at a specific weld location provides a major departure from known art. This portability provides considerable advantages when used in the field as a robotic welding head 508. Instead of a work piece being brought to and located proximate a fixed robot, this apparatus brings the welder to the work piece—in this case railroad rail 10—and uses interfacing with rail 10 to automatically weld the slot 28 in rail 10. The use of touch sensing enables controller 116 to precisely align and operate the welder head 440 to form a precisely controlled and metallurgically sound weld in very tight spaces.

The robotic welding head 508 may be loaded onto the welding skid 506 for transportation, and storage. It may also be unloaded and extended for maintenance or for welding of the rail. The robot 500 welding range from the weld delivery unit is only limited by the length of the umbilical 510. Thus the robot 500 can be readily and quickly stored or deployed for use. The portable welding robot 500 could function as a stand-alone device or be temporarily clamped to the rail repair alignment device 201 for welding. The joined rail repair alignment device 201, portable welding robot 500, weld containment device 290 and the protection shield 512 function together as the robotic welding head 508. As a combined unit, the robotic welding head 508 can center the rail-void interface, contain and produce the weld. The robotic welding head 508 functions with the aid of an umbilical 510 that extends from the robotic welding head 508 to the weld delivery unit 100. The umbilical 510 is a flexible group of cables that enable the robotic welding head 508 to make the weld. The welding skid contains the robot controller 514, shielding gas 516, hydraulics 518, compressed air 520, welder power leads 522, grounding cable 524, induction heater 526, boom 504 and coolant hoses 528. The materials located on the skid supply the robotic welding head 508 through the use of the umbilical 510. The welding robot 500 and rail repair alignment device 201 can be separated for easier handling by employees or can be moved as a one piece unit by using the boom. If the weld location is such that the robotic welding head 508 cannot be placed by use of the boom 504 then the welding robot 500 and the rail repair alignment device 201 can separated and carried to the weld site. Alternatively, the welding skid 506 can be outfitted with multiple robotic welding heads 508 so several weld voids can be welded simultaneously. The ability to weld several voids at the same time is desirable in high rail traffic areas such as on commuter lines where trains travel on strict schedules.

The protection shield 512 is attached to the rail repair alignment device 201 and can be made out of plexiglass or other weather shielding material. During welding, the protection shield is moved to the closed position, which encloses the weld area, protecting the welding robot 500 and the weld from wind and other elements which may affect the accuracy of the welding procedure.

The robotic welding head 508 is positioned at the weld slot by first removing it from the weld delivery unit 100 by using the boom 504. The robotic welding head 508 is positioned over the weld-void interface and the rail repair alignment device 201 is fastened to the rail 10 by use of the clamping members. Once the rail repair alignment device 201 is fastened to the rail 10 the robot controller 116 located on the weld delivery unit 100 instructs the robot 500 to determine the rail-void interface configuration and then maneuvers the robot 500 to create the weld. By being able to place the robotic welding head 508 within a close proximity to the weld-void interface, set-up is simplified and the time required is greatly reduced. By attaching the portable welding robot 500 to the rail repair alignment device 201, welding accuracy is greatly improved because a smaller, lighter robot can be used which decreases undesired movements during welding. Also, since the portable welding robot 500 is directly clamped to the rail 10, steadying devices and proximity adjustments are eliminated.

As many and varied modifications of the subject matter of this invention will become apparent to those skilled in the art from the detailed description given hereinabove, it will be understood that the present invention is limited only as provided in the claims appended hereto.

1. An on site railroad rail welding repair apparatus wherein a railroad rail is an operating railroad track and a defect in the rail has been removed to provide a void and a rail-void interface while maintaining continuity of the rail comprising: a pair of cooling blocks which have an internal configuration to complement the rail, and an arc welder that fills the void with appropriate molten metal and causes the molten metal and the rail at the rail-void interface to bond.

2. The on site railroad rail welding repair apparatus of claim 1 wherein the arc welder is a gas shielded arc welder, or electroslag arc welder, or a hidden arc welder, or an inert gas arc welder.

3. The on site railroad rail welding repair apparatus of claim 1 wherein the welder is such that the solidified molten metal is substantially free of inclusions and the solidified metal and rail each include carbon and the carbon content of each is similar.

4. The on site railroad rail welding repair apparatus of claim 3 wherein the weld metal includes between about 0.60% and 0.85% by weight carbon.

5. The on site railroad rail welding repair apparatus of claim 2 wherein the apparatus minimizes the annealing effect and heat affected zone of the rail-void interface and the welder is the inert gas shielded arc welder that has a solid weld electrode that has been treated so as to remove hydrogen and minimize hydrogen embrittlement.

6. The on site railroad rail welding repair apparatus of claim 1 further comprising
a frame for supporting a weld containment apparatus and adapted for aligning a welding head;
said weld containment apparatus having a pivotal and longitudinal component; and
a mobile weld delivery unit delivering an automated welder having a welder head proximate said void so that a weld can be made joining the rail-void interface.

7. The on site railroad rail welding repair apparatus of claim 6 wherein said weld containment apparatus is pivotally operated by use of a cam actuated linear pin in which longitudinal movement of the pin imparts pivotal movement in quadrants, and said quadrants having cooling blocks mounted thereto.

8. The on site railroad rail welding repair apparatus of claim 7 wherein said quadrants are pivotally connected to yokes;
said yokes are slidably mounted on longitudinal shafts said shafts being mounted on a frame member, such that longitudinal movement of the yokes on said shafts impart inward and outward pivotal swinging of said quadrants;
said inward and outward pivotal swinging of the quadrants enabling the engagement of the cooling blocks with said rail-void interface during welding and also enabling movement for clearance for the welding head to move reciprocally and vertically to weld the rail-void interfaces together, while closing the blocks to maintain the welding material in the web, and swinging to provide such clearance as is necessary to weld the head portion of the rail-void interface.

9. The on site railroad rail welding repair apparatus of claim 8 wherein said pin has a fixed end and a cam end opposite said fixed end;
said fixed end being fixed relative to said quadrant, and being pivotal in said yoke;
said cam end fitting a cam mounted in said frame member, such that said longitudinal movement is imparted from said frame to said yoke, and as said frame member moves longitudinally relative to said yoke, said cam imparts rotational movement in said end, said end rotating said pin and said fixed quadrant, thereby engaging and disengaging rail welding cooling blocks from said rail.

10. The on site railroad rail welding repair apparatus of claim 9 wherein said cam end is formed and arranged with between about 15 to 30 degrees twist in three quarters of one inch travel;
said rail restraint having a first frame for supporting a clamp and adapted to support a weld containment apparatus and further adapted for aligning a welding head,
said first frame having a fixed downwardly depending arm and a movable downwardly depending arm spaced there from defining a rail receiving space there between;
said movable arm is eccentrically pivoted on said frame to enable capturing of a rail in said space;
said movable arm being pivoted about a first pivot and a clamping force being applied to and released from a second pivot displaced from said first pivot;
said frame supporting a third pivot and said third pivot connecting with a link to said second pivot whereby an actuating force applied to said link transmits said clamping force through said link;
said link being a scissors link;
said scissors link having a fourth pivot joining a first part connected to said third pivot and a second part connected to said second pivot, and said actuating force being applied at said fourth pivot;
said mobile weld delivery unit having a vehicle body and a welder;
said welder being retractably and deployably carried in said body;
said welder being automatically controlled by a controller, said controller calibrating the operation of said weld relative to the location of said rails;
said weld operation calibration being performed based on touch sensing members located on said rail restraint;
said vehicle having a longitudinal axis;
said welder and controller coacting with a robot device to position a welder head based on said calibrated reference; and
said robot device having a base and a main axis, said main axis being aligned with the vehicle longitudinal axis.

11. The on site railroad rail welding repair apparatus of claim 6 further comprising:
a pair of rail clamps on the frame to hold said frame in position on said rail during the welding of the rail-void interface.

12. The on site railroad rail welding repair apparatus of claim 6 further comprising:
said mobile weld delivery unit having a vehicle body and a welder;
said welder being retractably and deployably carried in said body; and
said welder being automatically controlled by a controller, said controller calibrating the operation of said weld relative to the location of said rails.

13. The on site railroad rail welding repair apparatus of claim 12 wherein said vehicle has a longitudinal axis;
said welder and controller co-act with a robot device to position a welder head based on said calibrated reference;
said robot device having a base and a main axis, said main axis being aligned with the vehicle longitudinal axis.

14. The on site railroad rail welding repair apparatus of claim 13 further comprising:
said weld delivery unit including an induction heater for preheating said rails prior to welding.

15. An on site railroad rail welding repair apparatus wherein a railroad rail is an operating railroad track and a defect in the rail has been removed to provide a void and a rail-void interface while maintaining continuity of the rail comprising:
a mobile weld delivery unit delivering an automated welder having a welder head proximate said rail-void interface so that a weld can be made joining said rail-void interface;
said mobile weld delivery unit having a vehicle body and a welder;
said welder being retractably and deployably carried in said body;
said welder being automatically controlled by a controller, said controller calibrating the operation of said weld relative to the location of said rails;
said weld operation calibration being performed based on touch sensing members located on said rail restraint;
said vehicle having a longitudinal axis;
said welder and controller coacting with a robot device to position a welder head based on said calibrated reference;
said robot device having a base and a main axis, said main axis being aligned with the vehicle longitudinal axis;
said weld delivery unit including an induction heater for preheating said rail prior to welding.

16. An on site railroad rail welding repair apparatus wherein a railroad rail is an operating railroad track and a defect in the rail has been removed to provide a void and a rail-void interface while maintaining continuity of the rail comprising:
a first frame for supporting a clamp, a robotic welding apparatus and a weld containment apparatus and adapted for aligning a welding head;
said clamp adapted for restraining the first frame on said rail;
said weld containment apparatus connected to said clamp and engageable with said rail-void interface by movement having a pivotal and longitudinal component;
a mobile weld delivery unit delivering materials through an umbilical to said robotic welding apparatus having a welding device proximate said rail-void interface so that a weld can be made joining said rail-void interface.

18. The apparatus of 17 further comprising:
said controller coacting with said robotic welding apparatus through said umbilical to position a welding device based on said calibrated reference;
said robot welding apparatus having a base and a main axis, said main axis being aligned with the longitudinal axis of said rail.

19. A robotic welding apparatus for welding an operating railroad track where a defect in the rail has been removed to provide a void and a rail-void interface while maintaining continuity of the rail comprising:
said robotic welding apparatus being connectable to a rail wherein said robotic welding apparatus having a base and main axis, said main axis being aligned with the longitudinal axis of said rail.

20. The robotic welding apparatus in claim 19 further including an umbilical attached to a weld delivery unit wherein said umbilical transmits information to and from said weld delivery unit and further transfers welding materials to said robotic welding apparatus.

21. The robotic welding apparatus in claim 21 further including an attachment so said robotic welding apparatus can be releasably attached to one of a rail restraint device and/or a weld containment device.

22. The robotic welding apparatus in claim 20 wherein movement of said robotic welding apparatus while welding is being automatically controlled by a controller through said umbilical, said controller calibrating the operation of said weld relative to the location of said rail-void interface; and
said weld operation calibration being performed based on touch sensing different locations on said rail.
